(19) United States
(12) Patent Application Publication
(10) Pub. No.: US 2008/0054133 A1
(43) Pub. Date: Mar. 6, 2008

(54) SUPPORTING ARM FOR A MONITOR SCREEN

(76) Inventor: Yuan-Hsiang Huang, Taichung Hsien (TW)

Correspondence Address: LEONG C LEI, PMB # 1008, 1867 YGNACIO VALLEY ROAD, WALNUT CREEK, CA, 94598, US

(21) Appl. No.: 11/469,881

(22) Filed: Sep. 4, 2006

(51) Int. Cl. F16M 11/02

(52) U.S. Cl. 248/178.1

(57) ABSTRACT

A supporting arm for a monitor screen is disclosed. The supporting arm comprises a clipping seat, a securing seat, a support seat, a suspension arm and a cross-shaped joint formed into an integrated unit, and a cross-shaped linking frame of the cross-shaped joint, characterized in that the lateral sides of the vertical connector end of the linking frame is mounted with a plurality of pads, a load ratchet wheel, a clutch ratchet wheel, a mounting tube, a wave-shaped spring, a lateral seat and a circular rim by a screw bolt and a blocking nut, forming into an up-down joint mechanism for up and down adjustment of the monitor screen, the external face of the clutch ratchet wheel is provided with a plurality of protruded pegs, and the protruded peg is in engagement with a slot formed at the lateral seat, and the clutch ratchet wheel is in engagement with the load ratchet wheel such that after a prolong period of use, the clutch ratchet wheel will not move eccentrically or move downward.

### BACKGROUND OF THE INVENTION

(a) Technical Field of the Invention

The present invention relates to a supporting arm, and in particular, a supporting arm for LCD monitor which allows left and right and up/down swinging movement of the LCD monitor screen.

(b) Description of the Prior Art

FIGS. 1 or 2 show a conventional support arm for monitor screen comprising a base seat 10, a top seat 16, a suspension arm 20, a linking arm 22 and a spring 23. The upper end of the top seat 16 is a directional connector 161 linked to the connection seat of the monitor screen. The lower end of the suspension arm 20 is formed into a rotating knot with the first shaft 11 and the base seat 10. When the conventional support arm is adjusted to a required angle, the only resistance between a blocking shaft 15 positioned at the rear edge of the base seat 10 and the circular edge 223 of the linking arm 22 will cause these components to be wear off after a period of use, and therefore the positioning of the support arm is difficult. The resistance provided by the blocking shaft 15 and the circular edge 223 will not be able to withstand a heavy monitor screen.

Accordingly, it is an object of the present invention to provide a supporting arm for a monitor screen which mitigates the above drawback.

### SUMMARY OF THE INVENTION

The primary purpose of the present invention is to provide a clipping seat, a securing seat, a support seat, a suspension arm and a cross-shaped joint formed into an integrated unit, and a cross-shaped linking frame of the cross-shaped joint, wherein the two lateral sides of the vertical connector end of the linking frame is mounted with a plurality of pads, a load ratchet wheel, a clutch ratchet wheel, a mounting tube, a wave-shaped spring, a lateral seat and a circular rim by a screw bolt and a blocking nut, forming upon an up-down joint mechanism for up and down adjustment of the monitor screen, and the external face of the clutch ratchet wheel is provided with a plurality of protruded pegs, and the protruded pegs are in engagement with a slot formed at the lateral seat, and the clutch ratchet wheel is in engagement with the load ratchet wheel such that after a prolong period of use, the clutch ratchet wheel will not move eccentrically or move downward, causing the monitor screen to move downward.

Yet still a further object of the present invention is to provide a supporting arm for a monitor screen, wherein the supporting force by the suspension arm could be set in accordance with the weight of the LCD monitor screen.

The foregoing object and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a perspective exploded view of a conventional supporting arm for a monitor screen.

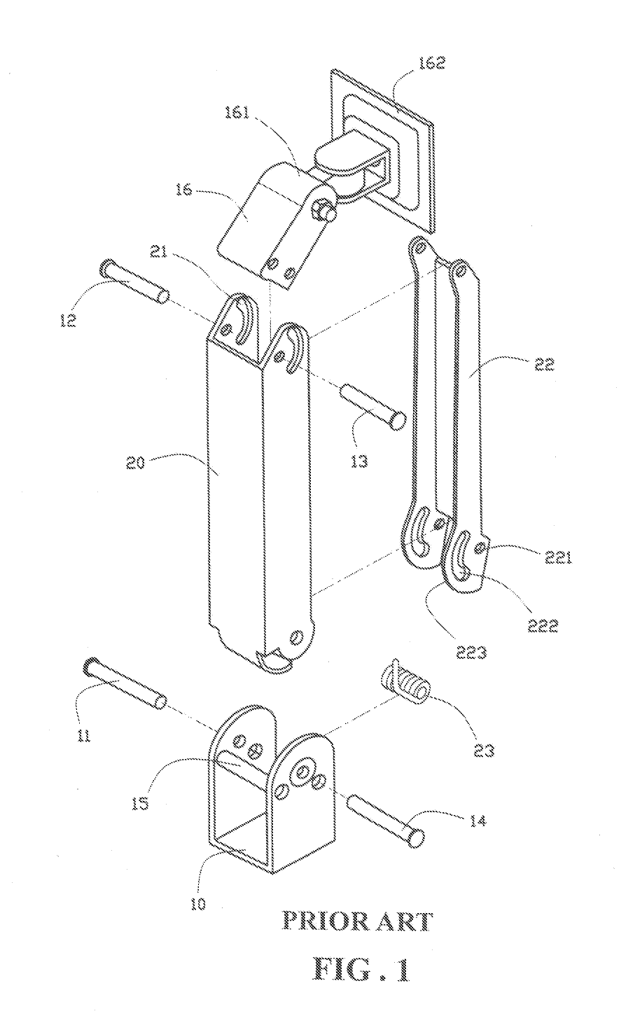

FIG. 2 is a sectional view of the conventional supporting arm for a monitor screen.

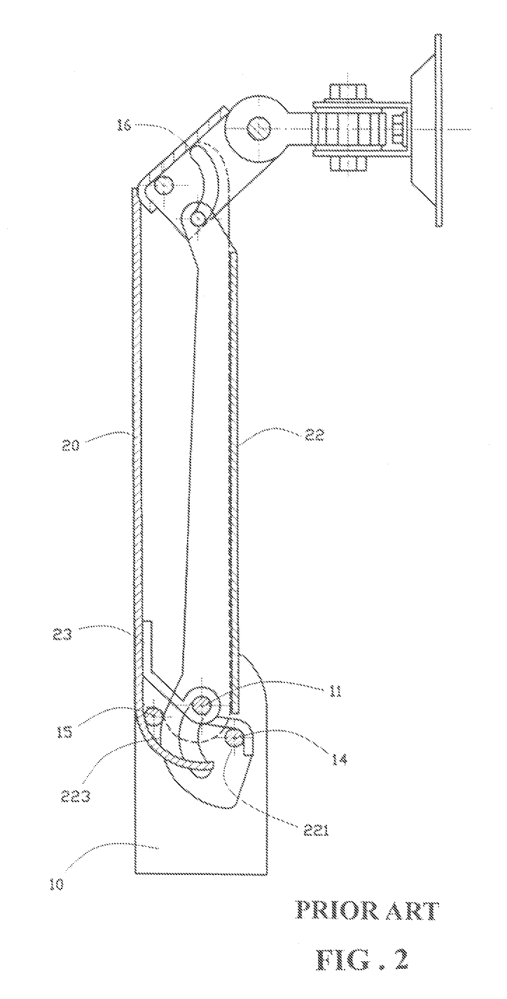

FIG. 3 is a perspective view of a supporting arm for a monitor screen in accordance with the present invention.

FIG. 4 is a sectional view of the present invention.

FIG. 5 is a perspective exploded view of the up-down joint mechanism of the present invention.

FIG. 6 is a sectional view of a cross-shaped joint of the present invention.

FIG. 7 is a schematic view showing the upward adjustment of the monitor screen of the present invention.

FIG. 8 is a sectional view of FIG. 7 of the present invention.

FIG. 9 is a schematic view showing the downward adjustment of the monitor screen of the present invention.

FIG. 10 is a sectional view of FIG. 9 of the present invention.

FIG. 11 is a perspective view of the resisting element of the present invention.

FIG. 12 is a schematic view showing the adjustment resisting element and the elastic retractable device of the present invention.

### DETAILED DESCRIPTION OF THE PREFERRED EMBODIMENTS

The following descriptions are of exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

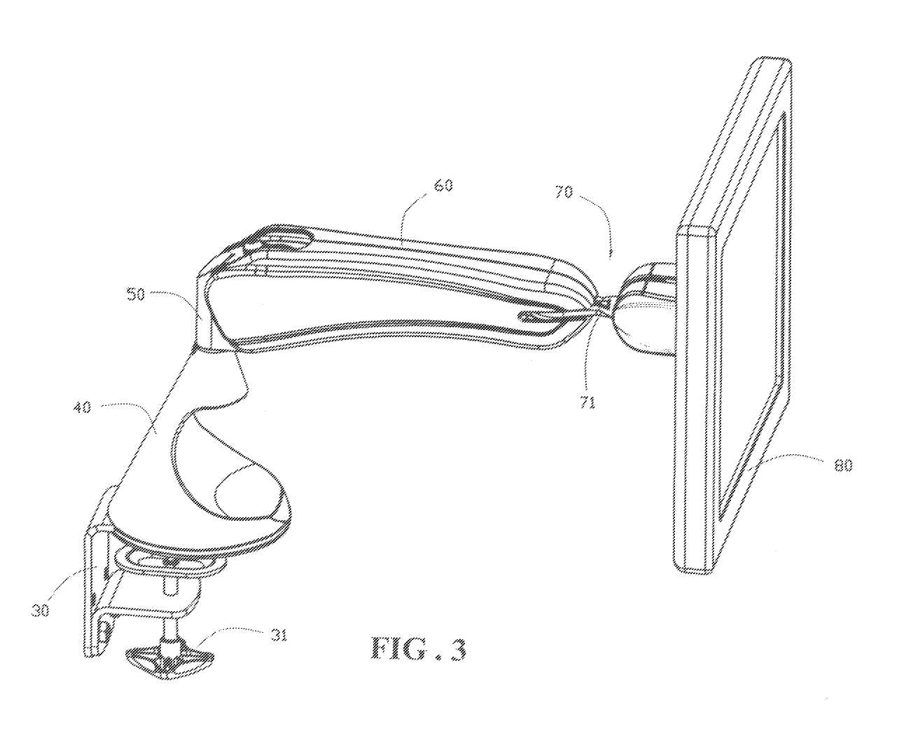

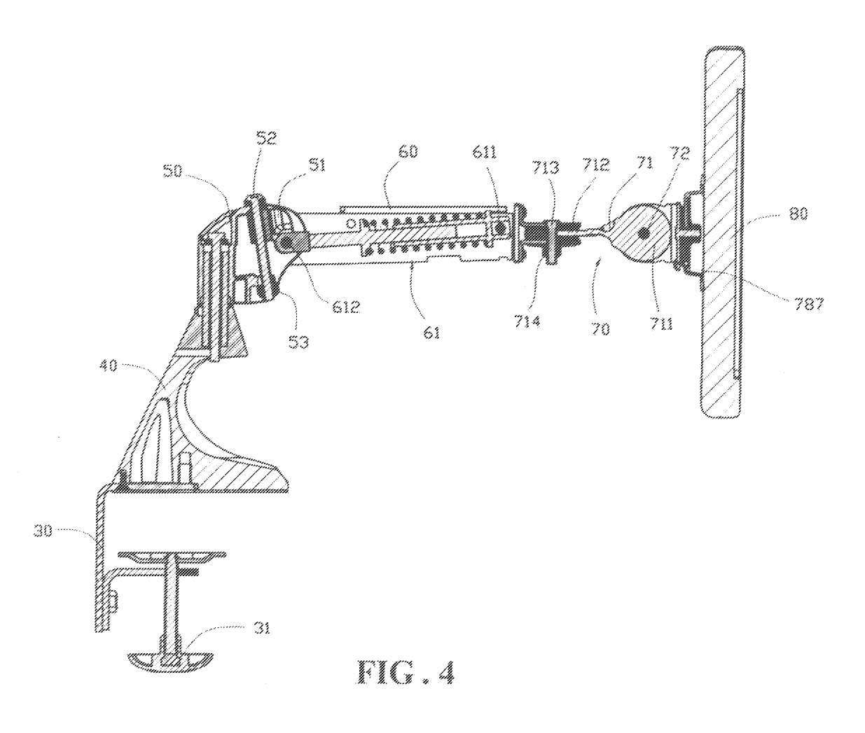

Referring to FIGS. 3 and 4, there is shown a supporting arm for a monitor screen comprising a clipping seat 30, a securing seat 40, a support seat 50, a suspension arm 60 and a cross-shaped joint 70 formed into an integrated body or unit. A handle screw shaft 31 of the clipping seat 30 is used for mounting at the table edge such that the monitoring seat 787 at the end of the cross-shaped joint 70 can be fixed with a monitor screen 80 and the monitor screen 80 can be adjusted at any angle.

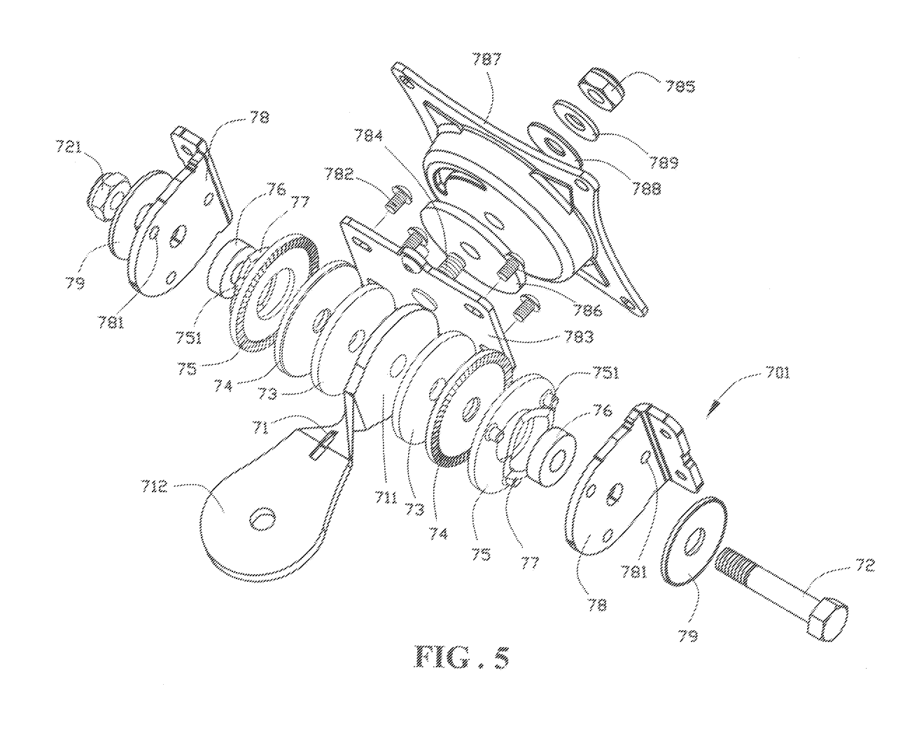

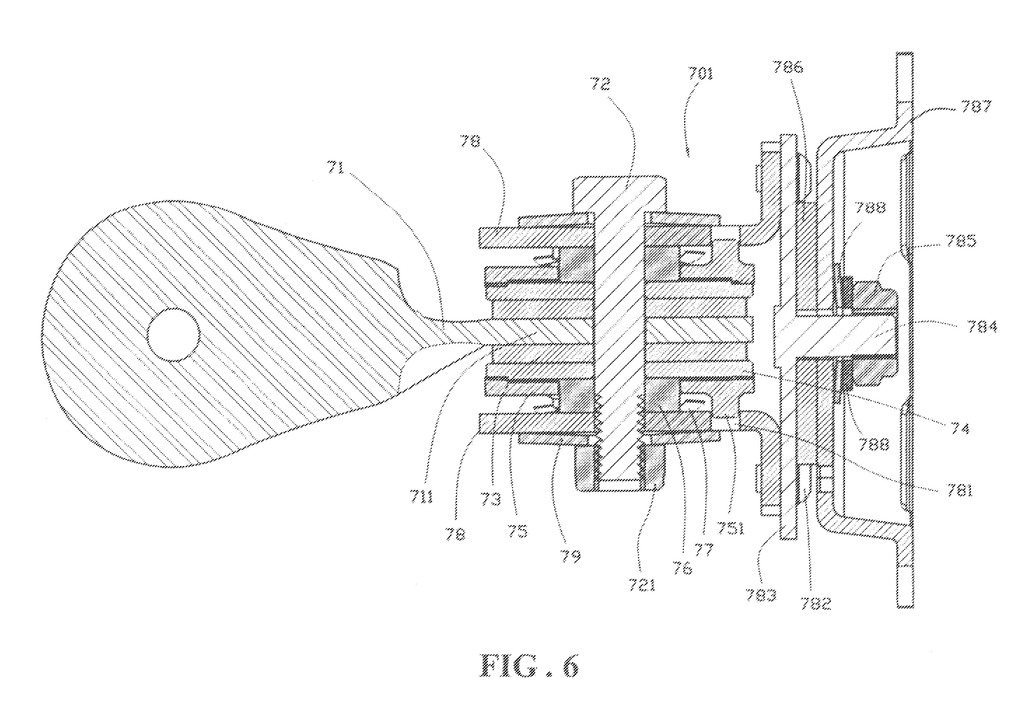

As shown in FIGS. 3 to 6, the two lateral sides of the vertical connector 711 of a support frame 71 is mounted in sequence a pad 73, a load ratchet wheel 74, a clutch ratchet 75, a mounting tube 76, a spring 77, a lateral seat 78 and a circular rim 79 by means of a screw bolt 72 and a screw nut 721. These components forms into a up-down joint mechanism 701 for up-down movement of the monitor screen 80. The external side of the clutch ratchet wheel 74 is provided with a plurality of protrusions 751. When in combination, the protrusions 751 are inserted into the slot 781 of the lateral seat 78, and the upright face of the lateral seat 78 is locked with a securing plate 783 by screw nut 782. The screw bolt 784 is locked in sequence with a large size pad 786, a combination seat 787, a wave shaped circular pad 788, and a pad 789. The other end of the support frame 71 is a horizontal connector 712 which is pivotally mounted at the end of the suspension arm 60 by means of the screw bolt and the screw nut 714 so as to provide left right adjustment of the monitor screen 80.

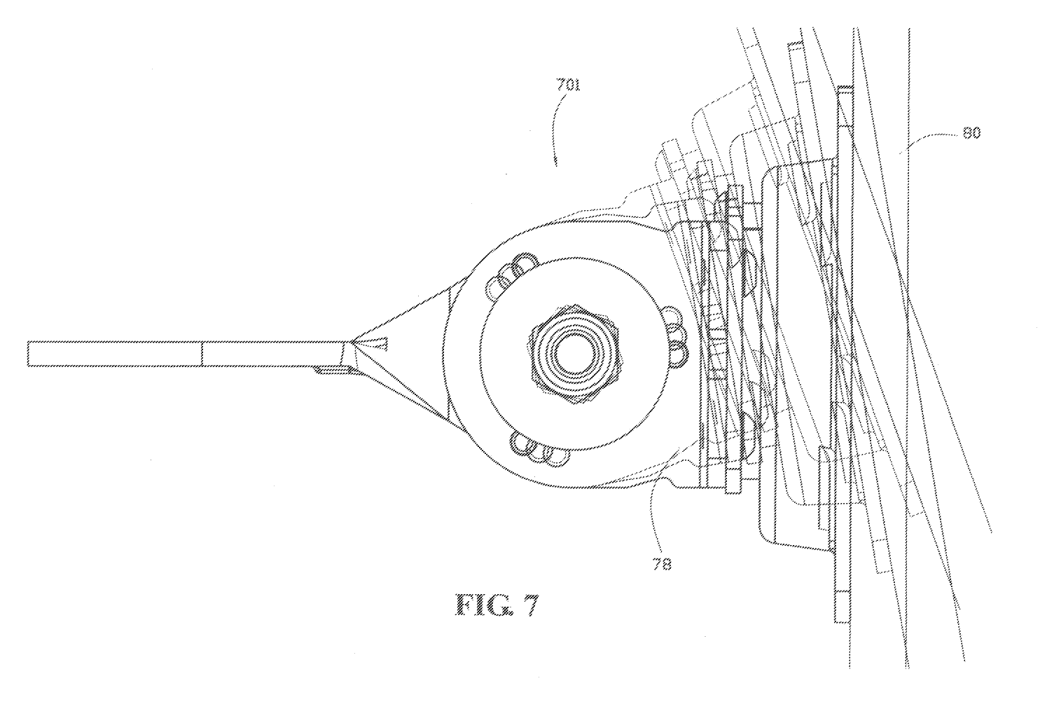

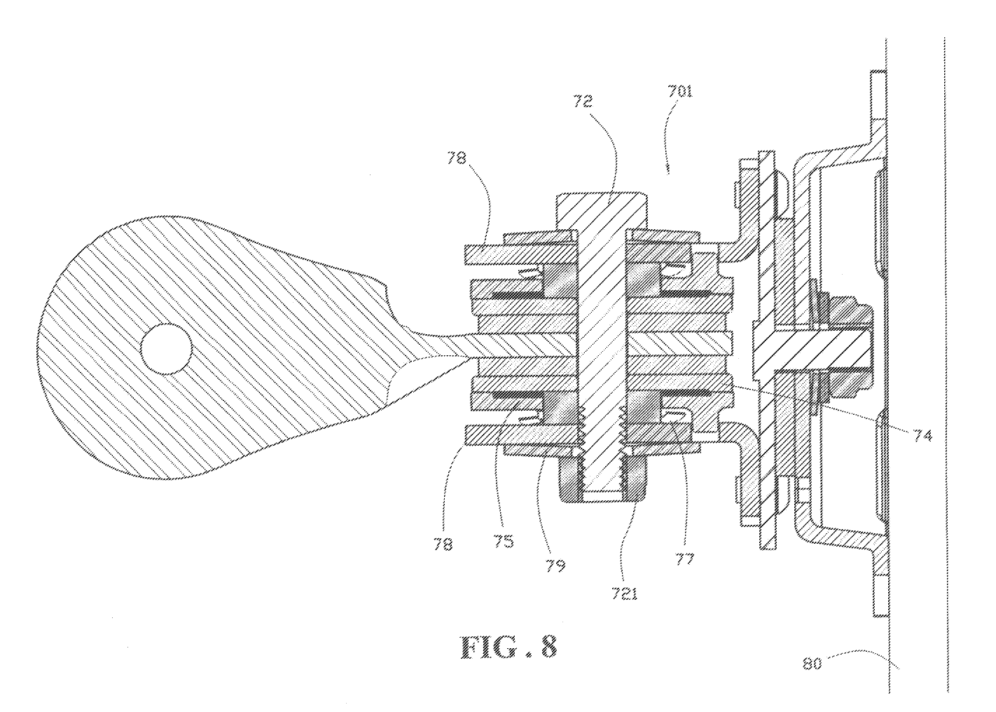

When the monitor screen 80 is to be moved upward, as shown in FIGS. 7 and 8, the lateral seat 78 of the up-down joint mechanism 701, the screw bolt 72, the blocking nut 721, the circular rim 79, the wave-shaped spring 77 and a clutch ratchet wheel 75 are rotated. The above movement will cause a disengagement of the clutch ratchet wheel 75 and the load ratchet wheel 74. Thus, the force needed to cause an upward adjustment is low.

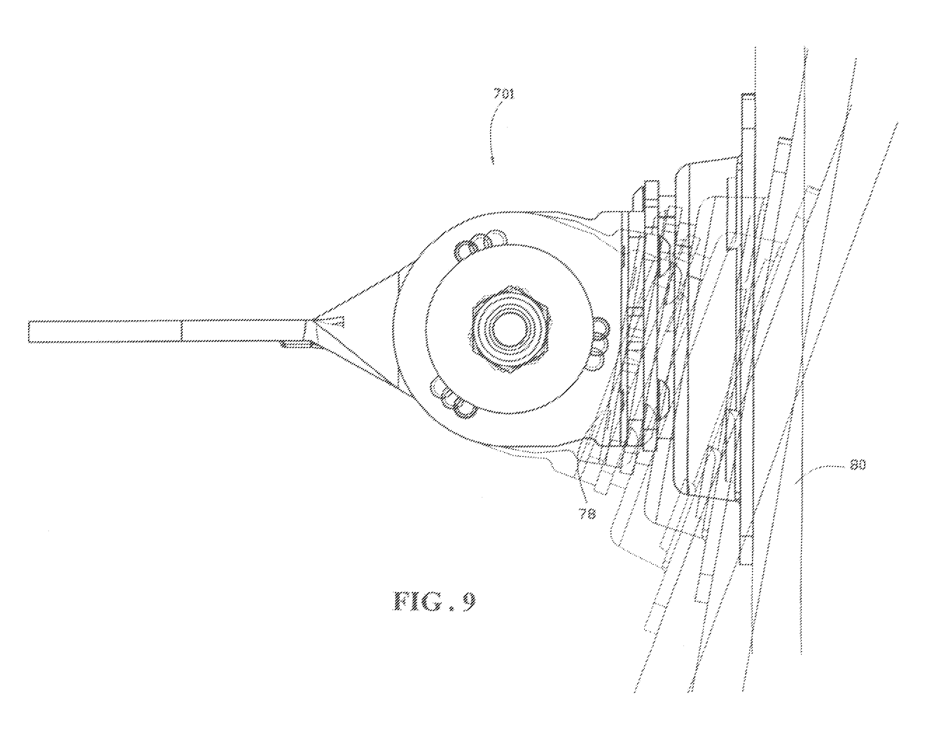

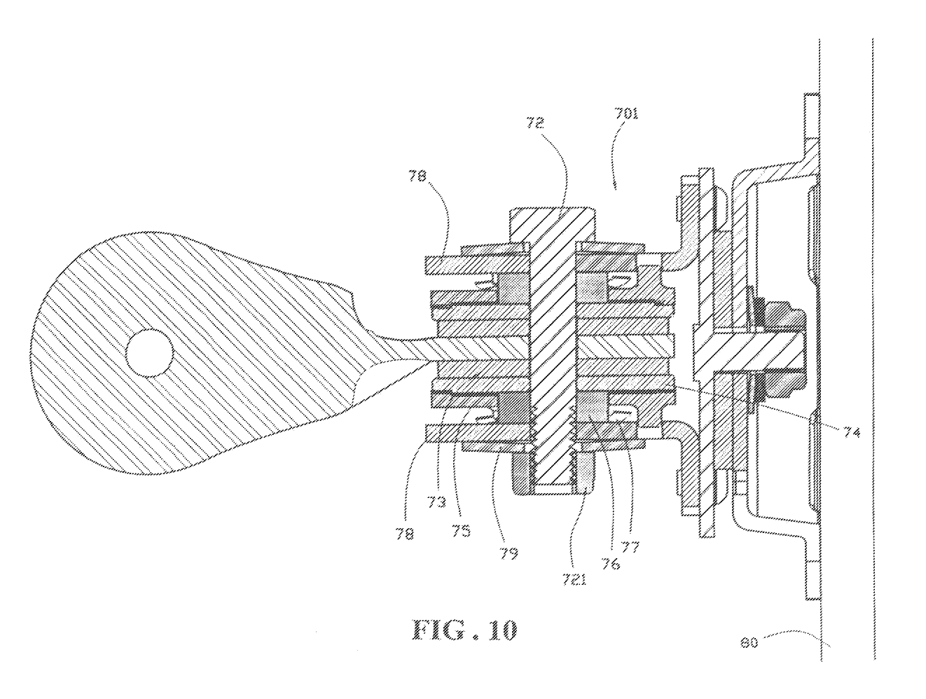

When the monitor screen 80 is to be moved downward, as shown in FIGS. 9 and 10, the lateral seat 78 of the up-down joint mechanism 701, the screw bolt 72, the blocking nut 721, the circular rim 79, the wave-shaped spring 77, the clutch ratchet wheel 75, the load ratchet wheel 74, the pad 73 and the mounting tube 76 are rotated. In the cause of the movement of these components, the clutch ratchet wheel 74 will engage with the load ratchet wheel 74 to move along. Thus, the force for downward adjustment is larger. In other words, the monitor screen 80 will not move downward.

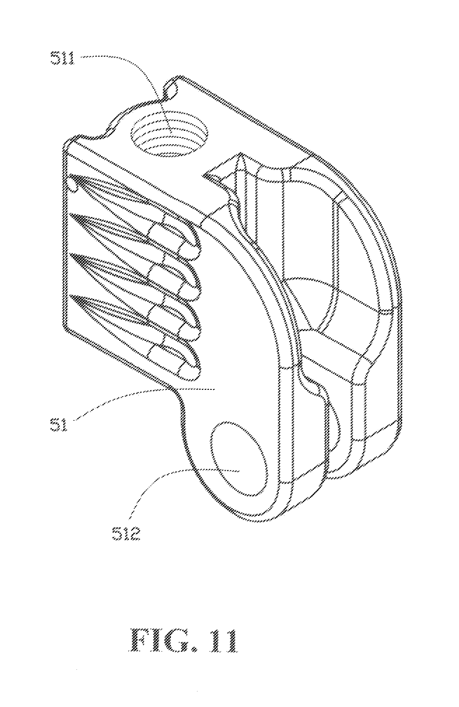

As shown in FIGS. 4 and 11, the interior of the suspension arm 60 is mounted with an elastic retractable device 61, and one end of the elastic retractable device 61 is pivoted to the suspension arm 60 by means of a peg 611. The other end of the retractable device 61 is pivoted to the resisting element 51 of the support seat by another peg 612, and the resisting element 51 is provided with a vertical slot 511, and the screw rod 52 and the blocking nut 33 are mounted within the support seat 50, the resisting element 51 is provided with a radial slot 512 such that the retractable device 61 is pivoted at one end by the peg 612.

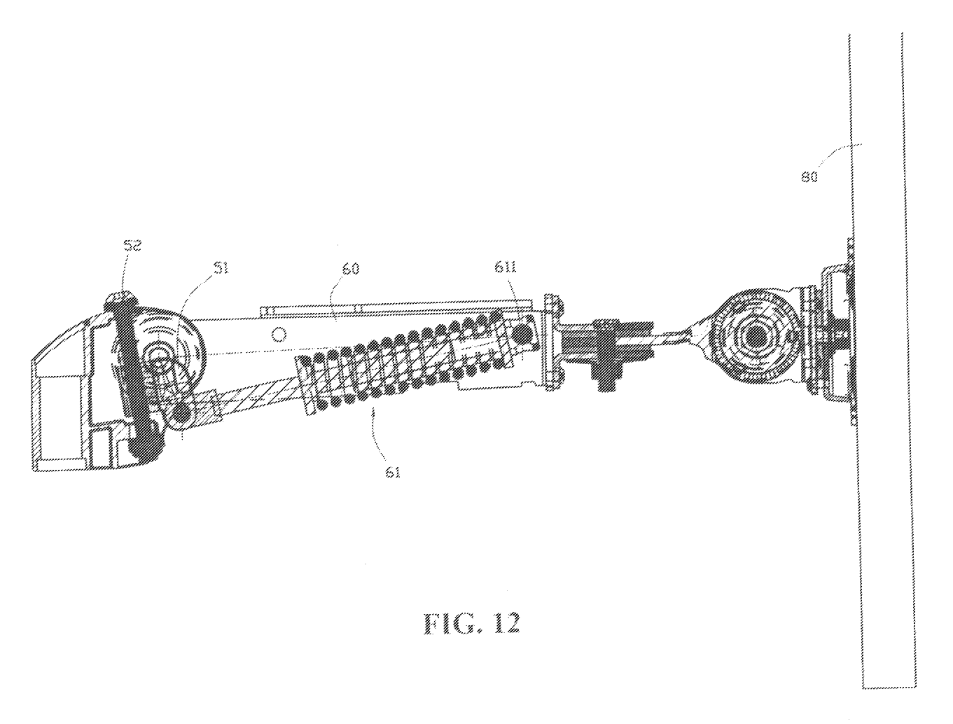

Referring to FIG. 12, rotating the screw rod 52 will control the height of the resisting element 51, and at the same time, the elastic retractable device 61 rotates to an angle about the peg 611. That is the larger the elastic retractable device 61, the larger the support of the suspension arm 60. Similarly, the smaller the elastic retractable device 61, the smaller the support of the suspension arm 60. Thus, based on the weight of the monitor screen, the appropriate supporting force of the suspension arm 60 is adjusted.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A supporting arm for a monitor screen comprising a clipping seat, a securing seat, a support seat, a suspension arm and a cross-shaped joint formed into an integrated unit, and a cross-shaped linking frame of the cross-shaped joint, characterized in that the lateral sides of the vertical connector end of the linking frame is mounted with a plurality of pads, a load ratchet wheel, a clutch ratchet wheel, a mounting tube, a wave-shaped spring, a lateral seat and a circular rim by a screw bolt and a blocking nut, forming into an up-down joint mechanism for up and down adjustment of the monitor screen, the external face of the clutch ratchet wheel is provided with a plurality of protruded pegs, and the protruded peg is in engagement with a slot formed at the lateral seat, and the clutch ratchet wheel is in engagement with the load ratchet wheel such that after a prolong period of use, the clutch ratchet wheel will not move eccentrically or move downward;
the interior of the support seat is provided with a resisting element having a vertical slot and the screw rod and the blocking nut are mounted within the interior of the support seat, and the resisting element is provided with a radial slot for pivotally mounting one end of the elastic retractable device,
thereby the rotating of the screw rod can control the height of the resisting element and simultaneously drive the elastic retractable device an angle about a peg.
